(19) United States
(12) Patent Application Publication
(10) Pub. No.: US 2026/0179355 A1
(43) Pub. Date: Jun. 25, 2026

(54) SYSTEM AND METHOD FOR IDENTIFYING AND COUNTING BIOLOGICAL SPECIES

(71) Applicant: Frontier Microscopy US Inc., Dover, DE (US)

(72) Inventors: David-Alexis MENDELS, Aix-en-Provence (FR); Gary John Hutton ATKINSON, Briantree Essex (GB); Henry Llyod THOMAS, Radyr (GB)

(21) Appl. No.: 18/706,943

(22) PCT Filed: Sep. 2, 2022
(86) PCT No.: PCT/GB2022/052248

§ 371 Date: May 2, 2024

(30) Foreign Application Priority Data
Sep. 6, 2021 (GB) 2112652.9

(51) Int. Cl. G06V 10/75; G06T 5/50; G06V 10/60; G06V 20/69

(52) U.S. Cl. CPC G06V 10/758; G06T 5/50; G06V 10/60; G06V 20/69; G06T 2207/10056

(57) ABSTRACT

A system and method for generating sample data for analysis provide an image capture unit configured to capture a stack of images in image layers through a thickness of a sample, each image layer comprising pixel data in two orthogonal planes across the sample at a given sample depth; a processing unit configured: a) to process the captured pixel data to determine therefrom a pixel value of the energy of each pixel of the image, b) to select from each group of pixels through the stack of images the pixel having a highest energy; and c) to generate an output image file comprising a set of pixel data obtained from the selected pixels, wherein the output image file comprises for each pixel, the pixel position in the two orthogonal planes, the pixel vale and the depth position of the pixel in the image stack. The depth position of the selected pixel is provided in a fourth channel of the output image file, which represents a topography of a sample. An analysis unit comprises an input for receiving the output image file and to determine therefrom sample data, including identification of constituents in the sample and/or quantity of said constituents in the sample; and preferably comprises an artificial intelligence.

### TECHNICAL FIELD

The present invention relates to systems and methods for identifying and counting biological species located for example on a microscope, preferably assisted by artificial intelligence. The systems and methods taught herein can be used in the sampling of a large variety of biological samples including, but not limited to, spores, tissue, cancers, blood and so on.

### BACKGROUND OF THE INVENTION

One basic task when analysing digital images from a microscope is to identify and count objects to perform a quantitative analysis.

As medical diagnostic and treatment procedures become ever more sophisticated, it is becoming necessary to improve the detection of biological samples in order to provide the data required for diagnosis and/or treatment. This requires not only the provision of ever better sampling systems and methods but also better data processing systems and methods in order to be able to handle the much larger amounts of data such systems can produce.

### SUMMARY OF THE PRESENT INVENTION

The present invention seeks to provide improved detection and analysing of samples, particularly biological samples.

According to an aspect of the present invention, there is provided a system for generating sample data for analysis including:
an image capture unit configured to capture a stack of images in image layers through a thickness of a sample, each image layer comprising pixel data in two orthogonal planes across the sample at a given sample depth;
a processing unit configured:
a) to process the captured pixel data to determine therefrom a pixel value of a predetermined parameter for each pixel of the image,
b) to select from each group of pixels through the stack of images the pixel having a value meeting a predetermined parameter condition; and
c) to generate an output image file comprising a set of pixel data obtained from the selected pixels,
wherein the output image file comprises for each pixel, the pixel position in the two orthogonal planes, the pixel value and the depth position of the pixel in the image stack.

The system disclosed herein generates a subset of image data comprising those values of those pixels in practice determined to be representative of an actual sample in the image, while removing from the output image data file pixel data that is deemed not to identify a sample. The filtering of data enables the subsequent processing of high quality and relevant data, improving the analysis of samples.

The disclosure herein is to a method and system that, rather than selecting an image from the stack of images, generates a new image formed of pixels at different depths within the sample, such that the newly generated image is representative of the actual item that is intended to be identified within the sample being imaged.

Advantageously, the predetermined parameter is energy of the pixel, preferably determined by measured luminance. While the preferred embodiments make use of the luminance of each pixel in the selection, the skilled person will appreciate that the teachings herein are not limited to used of luminance only and can be applied to any other measurable parameter of the pixels of the image. Examples include chrominance, hue, saturation and so on.

The preferred predetermined parameter condition is highest energy in through the stack of pixels in the same orthogonal positions.

Advantageously, the depth position of the selected pixel is provided in a fourth channel of the output image file. The depth position of the selected pixel for each of the orthogonal coordinate positions in the image can usefully represent a topography of a sample.

Preferably, there is provided an analysis unit comprising an input for receiving the output image file and to determine therefrom sample data, including identification of constituents in the sample and/or quantity of said constituents in the sample. The analysis unit advantageously comprises an artificial intelligence, preferably having the characteristics disclosed below.

In the preferred embodiments, the image capture unit comprises a microscope with a sample holder, wherein the sample holder is movable in X-Y planes, being the two orthogonal planes, and a focus of the microscope is movable in a Z-plane orthogonal to the X-Y planes. One of a microscope lens unit and the sample holder may be movable to adjust the focus of the microscope in the Z-plane. The microscope is preferably motorized in three orthogonal directions, so as to be able to perform a scan of the sample in a plane, along X- and Y-axes and through the thickness of the sample.

The images captured through Z-movement for a fixed (X, Y) position are preferably blended together by z-stacking, and a topography map is extracted therefrom.

The preferred system uses one of two methods to determine the maximum energy or other predetermined parameter condition for each pixel, variance and the Laplacian of Gaussian. Advantageously, the system computes for each image in the stack the variance for each pixel and its position in the stack is recorded where the variance is at its maximum, providing a variance mask. Preferably, the system performs for each image in the stack an enhancement step where a Gaussian blur is applied to the image, which is subtracted from the original image after applying a contrast enhancement factor to the two images and puts the resulting output through a second Gaussian blur filter before computing its Laplacian; wherein for each pixel, the position in the stack where the Laplacian of Gaussian (LoG) is at its maximum is taken, providing a second LoG mask for which pixel should be used from the stack. An invalid value is set in the mask if the maximum value falls below a given threshold.

The system is advantageously configured to determine if the value in the LoG mask is valid and if so to extract the pixel values from the stack at the position specified by the LoG mask and thereafter to compute and set RGB pixel channels and the value from the LoG mask in the final output image file; whereas if the value in the LoG mask is invalid, the system is configured to extract the pixel values from the stack at the position specified by the variance mask and thereafter to compute and set the RGB pixel channels and the value of from the variance mask in the final output image file.

Preferably, the system includes an object detector configured to identify objects within the captured images, the object detector being configured to process four-channel images.

The system is able to determine location of spores, pollen, blood constituents and/or disambiguate similar species.

According to another aspect of the present invention, there is provided a method of generating sample data for analysis including the steps of:
capturing a stack of images in image layers through a thickness of a sample, each image layer comprising pixel data in two orthogonal planes across the sample at a given sample depth;
processing the captured pixel data to determine therefrom a pixel value of a predetermined parameter for each pixel of the image,
selecting from each group of pixels through the stack of images the pixel having a value meeting a predetermined parameter condition; and
generating an output image file comprising a set of pixel data obtained from the selected pixels,
wherein the output image file comprises for each pixel, the pixel position in the two orthogonal planes, the pixel value and the depth position of the pixel in the image stack.

The method preferably comprises steps that perform the functions of the system, as disclosed herein.

The method may include the steps of:
scanning a first few fields to characterize a slide using a “slide classifier”
setting path for scanning in plane accordingly
at each point (x,y) in the plane, acquiring a stack of images though thickness with z-movement
stacking the resultant images in a format able for interpretation by both a field classifier and an object detector
performing classification of the field stack image
If the field is valid, performing object detection on the field stack image
storing field results in test results including: object, class, location, probability of class detection
calculating a relock stack index from a grey level variance of objects and applying focus correction on the next step
repeating the above steps until the end of a pre-determined path or condition is reached
reporting test results

The method may also include:
providing results in a log book
optionally providing a QC mark on samples for those that should be checked by a human analyst
optionally rejecting samples that have a large number of defects

Artificial intelligence (AI) enables the automation of this tedious task, increasing productivity through streamlining workflows, limiting errors and the influence of the subjectivity of the analyst.

The teachings herein generate a fourth channel of data in the capture, storing and analysis of micro-biological samples imaged by an imaging device, such as a microscope. That fourth data channel could be described as representing the topography of a sample and is particularly useful in the rationalization of data that needs to be processed to analyse the constituent make-up of a sample and in the optimisation of data that is received and processed. This can result in significantly more accurate and complete data, as well as significantly faster processing speeds and as a consequence reduced processing requirements.

When this data set is provided to a processing system, in particular an artificial intelligence system, it can also improve the sensitivity and specificity of the analysis. The inventors have found that in practical examples of microscopy slides, an artificial intelligence could benefit from additional information of the type that can be provided by the system and method disclosed herein, resulting in an increase of the sensitivity and specificity of the models. This can relate to a number of models used in AI for microscopy, including: classifiers, object detectors, and instance segmentation. The disclosure herein focuses in particular upon classifiers and object detection; however it is to be understood that the teachings herein are not limited to these only.

In the disclosed practical embodiment, the microscope apparatus is motorized in three orthogonal directions, so as to be able to perform a scan of the sample (the microscope slide) in plane, along X- and Y-axes, and through the thickness, along the Z-axis. Images are captured along every step of the movement.

The images captured through Z-movement for a fixed (x,y) position are blended together in the preferred embodiments by a process called z-stacking, and a topography map is extracted during this process. The method and system disclosed herein preferably combine two approaches to cancel some of the inherent weaknesses that can occur if just a single approach is used.

The topography map generated by the disclosed system and method is preferably stored in a fourth channel. Images usually consist of three information channels (for example R, G, B for the Red Green and Blue channels) and one unused channel (A, for the alpha channel). The preferred embodiments store the fourth data in the otherwise unused channel without any loss.

The system and method disclosed herein can be used in the analysis of a large variety of objects and substances, particularly microbiological species. Microbiological species of interest include but are not limited to: constituents of blood and other human/animal body fluids, mold spores, pollens, plankton and many more.

Other aspects and advantages of the teachings herein will become apparent to the skilled person from the specific description of preferred embodiments that follows.

### BRIEF DESCRIPTION OF THE DRAWINGS

Embodiments of the present invention are described below, by way of example only, with reference to the accompanying drawings, in which:

FIGS. 1A and 1B perspective and side elevational views, respectively, of an example microscope to which the teachings herein can be applied;

FIG. 2 is a graph illustrating a representation of the LoG and curvature along a stack;

FIG. 3 is a flow chart of an embodiment of the preferred method; and

FIGS. 4A to 4C depict a YOLO architecture that can implement the teachings herein.

### DESCRIPTION OF THE PREFERRED EMBODIMENTS

The preferred embodiments described below focus upon implementations using a microscope to analyse samples, typically biological samples. The use of a microscope is the primary intended use although the skilled person will appreciate that the teachings herein are not limited to such and other devices could be used to obtain data of samples to be processed by the system and method taught herein.

The preferred system enables the automation of image capture by biological microscopy such as bright field, inverted bright field, phase contrast, differential interference contrast or dark field microscopy methods. In the preferred embodiment, the system comprises:
1) a microscope, which may or may not be motorized, for the capturing of microscope images of samples typically on a microscope slide, Petri dish or other such suitable holder;
2) a drive mechanism configured to drive the automated microscope, in the case of a motorised microscope; and
3) processing apparatus and methods to capture and analyse the microscope images.

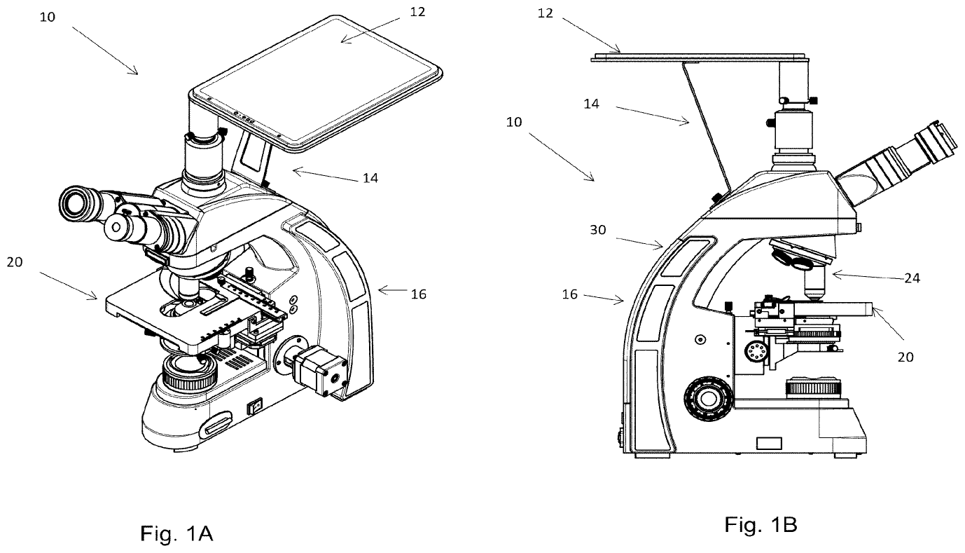

The preferred embodiments make use of a motorized microscope, such as the microscope 10 depicted in FIGS. 1A and 1B, controlled by a processing unit 12 which may usefully be a smartphone or tablet held on a support 14 coupled to the microscope body 16. The processing unit 12 is used to capture images from the microscope 10 and quasi-simultaneously to analyse the images, including while the microscope stage 20 is moved in and out of the focus plane.

A combination of digital image filters, image analysis methods and artificial intelligence built into the processing unit 12 are used to better the image analysis and count microbiological species.

The microscope stage 20 is fitted with two step motors for the x-direction and the y-direction, while a third step motor is advantageously fitted on the focus knob. The stepper motors are driven by a set of micro-controllers fitted on a printed circuit board (PCB). A light source is also powered by the PCB. The PCB is provided with a remote-control or communications unit, enabling the three stepper motors and the light source to be controlled remotely by the processing unit, such as smartphone or tablet 12. In one example of the device, the remote control is performed by means of a Bluetooth chip, although other possibilities are envisaged. For instance, a wired connection can be used to drive the PCB from the smartphone or tablet, for instance via an Ethernet connection. In this version of the hardware, the focus is obtained by moving the stage 20 of the microscope in the z-direction, while the objective 24 is anchored to the arm 30 of the microscope directly or by means of a turret. The processing unit 12 used to capture and process the microscope images is mounted on the microscope 10 preferably using an adapter, on a trinocular tube, although it could replace one of the eyepieces.

In another example, implementation, the hardware reduces the microscope to its basic optical axis. A stand less prone to vibration can be used instead of a curved geometry, with the straight geometry being further exploited to fix in position the optical elements along its main axis of the microscope. From bottom to top, the light source, an optional phase condenser and focusing lens, a microscope objective with optionally a phase ring at the back, and an eyepiece are all aligned in a single optical axis. Such geometry allows one to have a stage that moves only in-plane, that is in the x- and y-directions through their respective motors, while focus is obtained by moving the stage in the z-direction. In one example implementation of this device, a plateau supporting a smartphone or tablet 12 is fixed in position at the top of the device, where the centre of the lens of the smart phone or tablet is in alignment with the optical axis of the apparatus.

Any arrangement of microscope objective is possible, preferably able to image biological samples with between 10× to 100× magnifications. Due to the low constraints of accuracy of displacement, the motors for the x- and y-direction displacements can be coupled to drive directly the stage. In such an arrangement a cog may be mounted on the axis of the motor where its pinions are in direct contact with the trammel of the stage to drive it. The axis of the motor can either be orthogonal or parallel to the axis of the trammel. As the displacement accuracy supports a measure of randomness, any backlash resulting from such an arrangement is found acceptable.

The processing unit 12 is configured, typically by software, to perform three primary tasks in addition to the user interface, namely:
driving the motors
capturing images
analysing images.

In the preferred embodiments, in order to reduce acquisition and processing times, these tasks are dispatched in three separate queues, which are run asynchronously, that is performed independently from one another. The only synchronous process is the updating of the user interface whenever a result (count) is completed, or the analysis is complete.

The analysis is preferably autonomous and the system configured such that a single input button or other command is used to start and stop the analysis. Progress indicators are preferably displayed on a display of the device 12 when the analysis is running, respectively for the fields count and the objects count.

### Method

There follows a description of the preferred methods used to scan the sample in three orthogonal directions. It will be appreciated that the system will including processing modules configured to the method steps, and that these could be in hardware, software or a mixture of the two.

In a fully autonomous biological microscope, the system and method scan a few fields and classify them, thereby identifying the type of sample. Depending on the sample, a path is then chosen to scan the sample. The preferred paths for the preferred embodiments comprise:
Blood thick smear: as a rectangular spiral centred on the starting point, at the centre of the smear;
Blood thin smear: as a sinusoidal vertical path to scan the plume of the smear
Plankton: in a full slide scan
Mold: as a sinusoidal horizontal or vertical path to scan a trace of 10×1 mm.

It will be appreciated that a path will in at least some cases be dependent upon the nature and type of sample being analysed, and that the appropriate paths can be identified by the skilled person.

In all cases the preferred system and method alternate movement in the X- or Y-direction with a scan through the thickness of the sample in the Z-direction. The number of acquisition steps in the Z-direction and their value is a function of the analysis carried-out.

### Image Stack-Capture

Colour images are captured in the form of luminance and chrominance, YCbCr, a family of colour spaces used as a part of the colour image pipeline in video and digital photography systems. Y is luminance, meaning that light intensity is nonlinearly encoded based on gamma corrected RGB primaries, while Cb and Cr are the blue-difference and red-difference chroma components. A stack of images is captured as the stage of the microscope moves in the Z-direction, which affects the focus of the images of the stack. In other words, for each X-Y position (pixel) of the sample, a series of images is obtained through the depth of the sample. The number of Z-direction images or layers obtained will be dependent upon the sample and the resolution desired. In some preferred cases, between 28 and 60 images in the Z-direction are taken through the sample.

The intention is to determine the position in the stack where each pixel is at its maximum focus, that is most in focus. This is referred to as the pixel that has the most energy. The value of this pixel's position in the stack provides an extra dimension in the data for processing by the processing unit 12, which advantageously is assisted by AI.

In practice, the pixels of highest energy across a sample will not necessarily all be at the same height in the sample. As a consequence, the identification of the pixels with highest energy will create a sub-set of the original data, that subset comprising only the pixels of maximum energy in the vertical direction and potentially having different vertical positions. However, the position of each selected pixel is recorded, using the fourth data channel.

### Image Stack—Processing

The processing to determine the position of maximum focus is only preferably performed on the greyscale luminance channel Y. This optimises processing efficiency.

In the preferred embodiments two methods used to determine the maximum energy for each pixel, its variance and Laplacian of Gaussian (LoG). We compute the variance Var(x,y) for a pixel p_{(x,y)} within a given square window of length n.
Let:

$$k = \frac{n - 1}{2}$$

Where n is the size of a square window around a pixel and is an odd number.
The variance of a pixel (x,y) is:

$$Var ( {x}_{x} y ) = \frac{1}{{n}^{2}} {\sum }_{i = x - k}^{i = x + k} {\sum }_{j = y - k}^{j = y + k} {( {p}_{( i , j )} - μ )}^{2}$$

Where μ is the pixel value average

$$μ = \frac{1}{{n}^{2}} {\sum }_{i = x - k}^{i = x + k} {\sum }_{j = y - k}^{j = y + k} {p}_{( i , j )}$$

The Laplacian of Gaussian (LoG) is an operator to detect edges in an image, also called Marr-Hildreth operator. The Gaussian function is

$$g ( x , y ) = \frac{1}{2 {πσ}^{2}} {e}^{- \frac{{x}^{2} + {y}^{2}}{2 {σ}^{2}}}$$

The Laplacian operator is applied in Cartesian coordinates

$$Δ = \frac{{\partial }^{2}}{\partial {x}^{2}} + \frac{{\partial }^{2}}{\partial {y}^{2}}$$

Both methods have their own strengths and weaknesses when determining the energy of a given pixel. By combining both methods, these inherent weaknesses can be effectively eliminated.

For each image in the stack, its variance is computed. For each pixel, its position in the stack is recorded where the variance is at its maximum. This gives a variance mask for which pixel should be used from the stack.

As for variance, the same procedure is performed for the LoG. For each image in the stack, an enhancement step is performed where a Gaussian blur is applied to the image and this is subtracted from the original image after applying a contrast enhancement factor to the two images. The resulting output is put through a second Gaussian blur filter before computing its Laplacian. For each pixel, the position in the stack where the LoG is at its maximum is taken. This gives a second LoG mask for which pixel should be used from the stack.

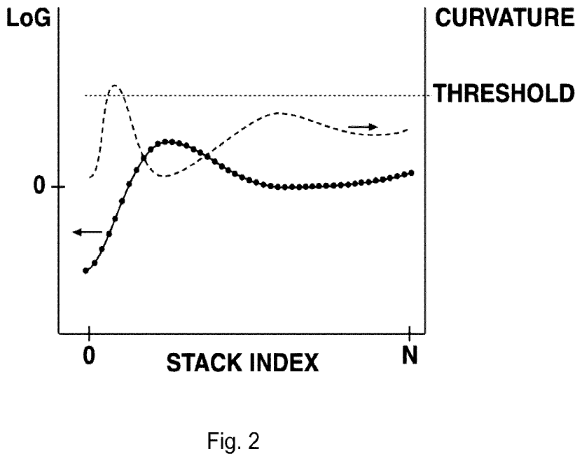

In computing the stack position, the system and method check whether the maximum LoG exceeds a minimum curvature threshold. FIG. 2 illustrates a representation of the LoG and curvature. The LoG curve is a guide for the eye, as the values are discrete along the stack index. The dashed curve is the curvature of the LoG curve (smoothed). In the case presented, the dashed curve exceeds a given threshold, so that the stack position is valid. If this value is not exceeded, the stack position is marked as invalid. The pixel value at the location is taken as the maximum of the LoG in the case of a valid stack position.

For all of the above processing there are a number of parameters that can be changed to determine the best results when computing the stack position. To compute the final consolidated image for processing by the processing unit 12; for each pixel the value of the LoG mask is taken and it is determined whether it is valid. If so, the pixel value is taken at the stack position indicated by the LoG mask. If the LoG stack position is invalid, the system/method reverts to using the stack position determined by the variance mask. The pixel value at the stack position is extracted in its YCrCb components and converted to RGB. All four components of Red, Green, Blue and Stack Position are stored for each pixel in the final consolidated image. This data is then passed to the processing unit, preferably assisted by AI.

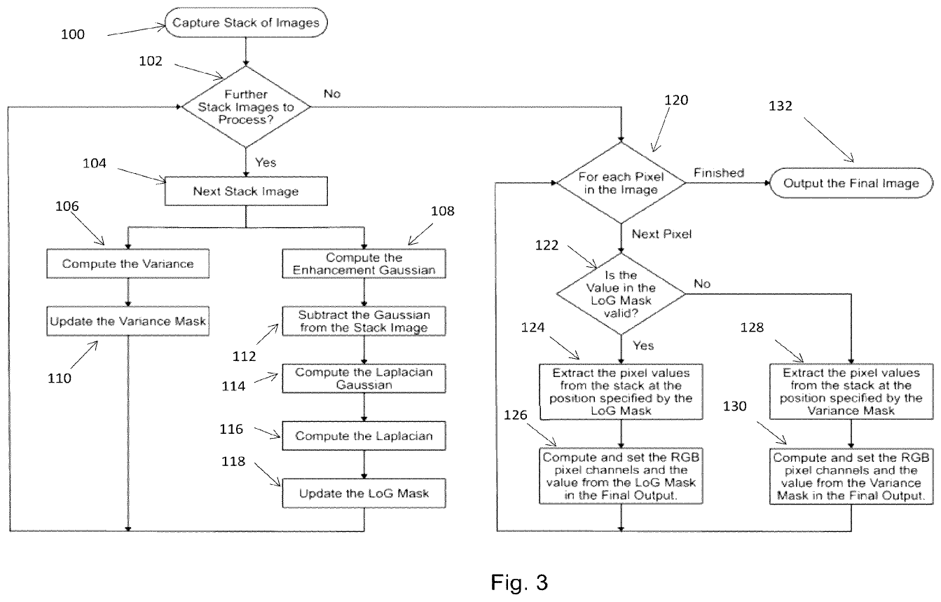

This processing is shown in flowchart form in FIG. 3.

More specifically, the process starts at step 100, in which the system/method captures a stack of images. At step 102 it is determined whether any further image stacks or layers are yet to be captured. If all the layers of the stack have been captured, the system/method moves onto the processing stage described below.

If further stack images are to be obtained, the method progresses to step 104, at which the next image stack layer is obtained. Both the variance and the enhancement Gaussian are computed, at steps 106 and 108 respectively.

From step 106, the variance Mask is updated with the newly computed variance (step 110) and the process then returns to step 102.

From step 108, the method subtracts the Gaussian from the stack layer image, at step 112, then the Laplacian of Gaussian at step 114 and subsequently the Laplacian (step 116). At step 118 the LoG mask is updated before returning to step 102.

It will be appreciated that processing will be carried out for each pixel in each stack layer.

Once all the image stacks have been captured and the variances and LoG computed and masks updated, the method proceeds to step 120. For each pixel of each stack layer in the image the method proceeds to steps 122 to 130. At step 122, the process determines if the value in the LoG mask is valid, as explained above. If it is, the process moves to step 124, which extracts the pixel values from the stack at the position specified by the LoG mask and then, at step 126, the process computes and sets the RGB pixel channels and the value from the LoG mask in the final output.

On the other hand, if the value in the LoG mask is invalid, the process goes to step 128, which extracts the pixel values from the stack at the position specified by the variance mask and then, at step 130, computes and sets the RGB pixel channels and the value of from the variance mask in the final output.

Once each pixel has been processed, the method outputs the final image, at step 132.

### Image Stack—Storing for AI

As already explained, the preferred system makes use of AI in order to improve and optimise the analysis of samples, particularly biological samples.

To facilitate training of the AI facility of the processing unit 12, the colour RGB images along with their topographic stack position are preferably exported as PNG graphic files. PNG files are not lossy and they also allow the topographic values to be stored in the alpha channel, that is in a fourth currently unused data channel. These images can then be loaded into tools where they can be viewed visually and marked up with boxes surrounding the objects to be trained by the AI.

### Artificial Intelligence—Introduction

AI is used in digital microscopy for a number of tasks, with the following goals:
Colour normalization: GAN
Segmentation: U-Net present an advantage over most thresholding methods, including adaptive thresholding
Counting objects: often follows segmentation, contouring and classifying enables objects to be counted
Classification: fields or object classification

Most in the art are now concentrating on segmentation tasks. In the art of sample analysis, most research and development focuses on sequential processing, where one operation follows the other. This provides some check points that the skilled person is familiar with, where the quality of each step can be assessed independently.

For the purpose of the teachings system and method taught herein the inventors have developed a systematic approach that ties together image classification at the field level, and object detection, which they believe is the most efficient path towards characterizing samples, detecting and classifying objects in one unified workflow.

### Image Classification

Image classification is a basic problem in computer vision. Convolutional Neural Networks (CNN) have reached human-like accuracy in image classification. They are usually composed of different basic layers such as convolutional layers, pooling layers, fully connected layers, which are cascaded sequentially. The convolution layers have parameters called weights and bias, referred to as model parameters.

The first layer of a CNN is the input image, from which a convolution operation outputs a feature map. The subsequent layers read this feature map and output new feature maps.

Convolution layers located at the front extract very coarse, basic features and in the intermediate layers they extract higher-level features. The fully connected layer, at last, performs scoring for classification.

The main interest of using a classifier in the system and method taught herein is to characterize the first few fields globally when the diagnostic begins. A few examples where it is used:
In malaria diagnosis—a classifier determines whether the field captured is a thin smear or a thick smear, and the object detector is selected accordingly.
In most diagnostics—a classifier determines whether the field is overloaded (i.e. with a background too important to distinguish objects) or should be further processed; which gives a measure of the validity of a field.
In some diagnostics—a classifier determines whether some objects such as bubbles and debris are present, as they may occlude the objects sought to be diagnosed.

One particular, but not exclusive, example of a classifier used in the system and method taught herein is EfficientNet.

### YOLO—Image Detector

When a field is classified as valid, it is further analysed by means of an object detector. The goal is to locate and classify objects within the field. One particular, but not exclusive, object detector is YOLO (You Only Look Once), for instance version 5 of this network. YOLO is a deep neural network architecture allowing the detection of objects given a set of anchor boxes. It works by separating the image with a grid where each cell is able to propose different bounding boxes for a given object. An objectness score is also returned by the network, so the user can set at which confidence a bounding box is to be kept.

For the purposes of the system and method disclosed herein, a modified YOLO network is used, which has been designed to accept four-channel images of various dimensions.

A second parameter is the IoU (Intersection over Union) which allows the system and method to obtain a correct superposition among possible propositions. The outputs are followed by a non-max suppression which leads to the correct bounding box proposals.

The input to the YOLO model can, hypothetically, be any number of channels. The number of convolutional operations within the first layer changes accordingly, since the convolutional kernels act on the channels separately.

Therefore, each pixel can be a vector of any length. In the preferred embodiments, it has been chosen to add the z-stack on top of the generic RGB value, resulting in 4 vectors for each pixel. As a result, as long as the CNN is large enough to handle the amount of data it receives, this added complexity can be used by the network to improve on Precision and Recall scores. This leads to two main improvements:
Location of spores. The IoU loss within the first few epochs is significantly improved, due to the presence of the fourth channel. Where there is roughness/topography, there is an object to characterize.
Disambiguation of some species that look alike, for instance penicillium and aspergillus.

Precision is the proportion of all the model's output labels that are correct. Recall is the proportion of all the possible correct labels that the model gets right.

Both TensorFlow or PyTorch may be used to train an image-classifier or object-detector. The resulting model is then converted to, for example, a Core ML model which is Apple's machine learning framework for implementation into iOS apps. Any other model could be used. The post-processing steps (mentioned below) are integrated within the CoreML model for ease of implementation.

In this particular implementation the system and method run both acquisition, pre-treatment, classification and YOLO on the GPU of the portable device, and post processing on the CPU.

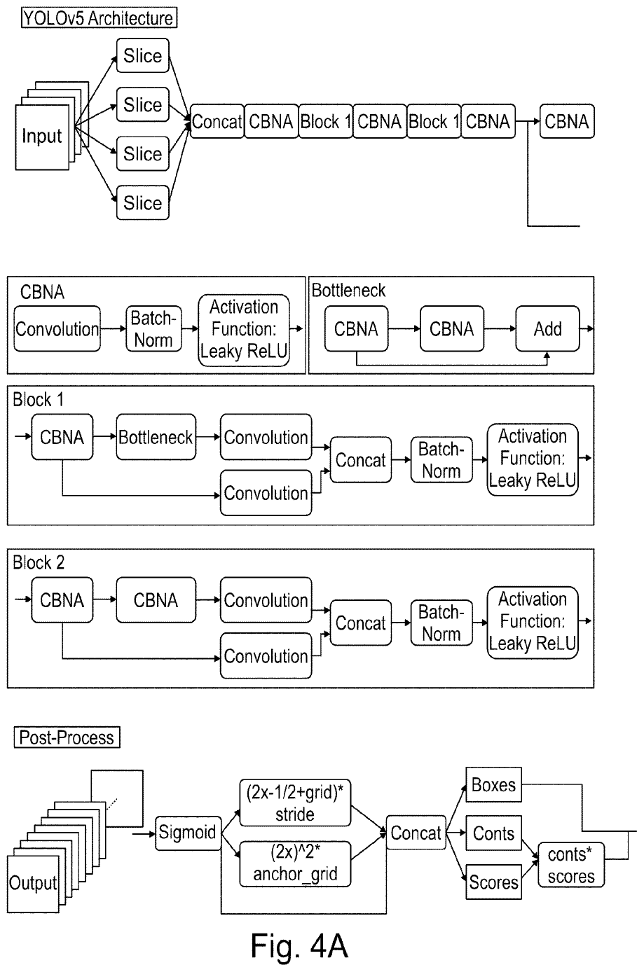

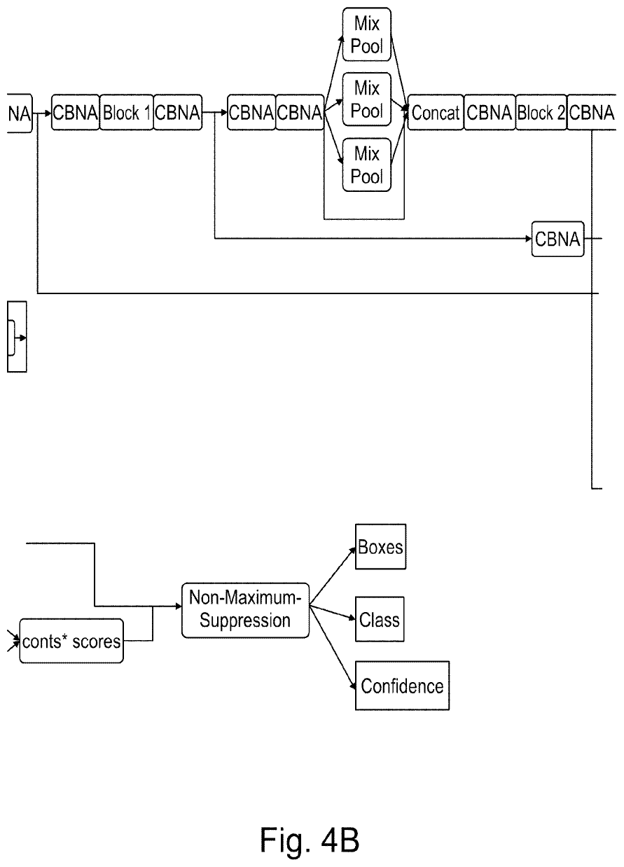

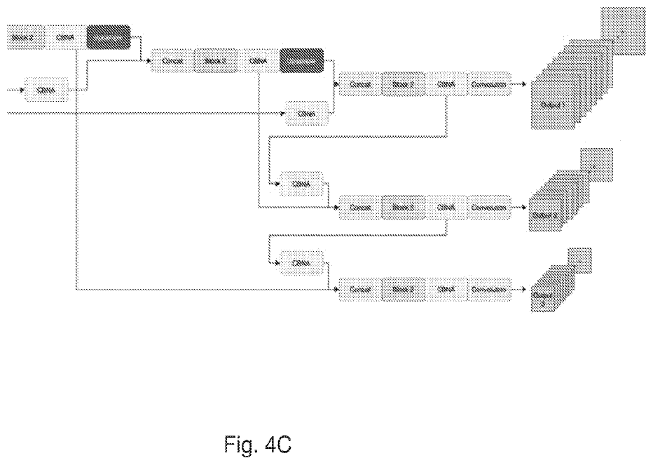

FIG. 4 shows an example implementation of a YOLOv5 system, augmented by use of a fourth data channel. This Figure is divided into three sections, 4A to 4C and with slight overlap between each section for the purposes of clarity.

### Post Processing

A specific post-processing is preferably first run on the output layer of the YOLOv5 network to get the confidence for each object class for all the anchor boxes. The anchor boxes are preferably three pre-set grids that fill that entire image with boxes that have three different sizes and strides. A pre-NMS confidence threshold is then run on these boxes to eliminate the many boxes that have no confidence in containing an object. Non-maximum-suppression (NMS) is then run on the remaining boxes. NMS involves an important hyper-parameter; the Intersection over Union (IoU) threshold, which is the proportion that two boxes may overlap before they are considered to contain the same object. NMS attempts to reduce significantly the number of boxes that are outputted as objects and ultimately only have one box per object detected. NMS can be class-specific and class-agnostic. The former is where IoU is carried out for each class of object independent from one another, and the latter is where IoU is carried out for all classes at the same time and the final box's class is simply the one with the highest score out of all the anchor boxes that made up the output box combined. Class-specific NMS is normally used when the confidence on one class has no relation to the confidence of another, whereas class-agnostic NMS is used when the confidences of different classes are correlated. For most object detection solutions on microscopic images, class-agnostic NMS has been determined to be best.

### Model Metadata and Hyper-Parameters.

An IoU threshold is chosen to be very slightly lower than the IoU threshold used during training. This helps the model not to double-label any large objects it has not seen before. However, this can increase how often small objects clumped together get labelled as one object. A balance should therefore be found for the IoU threshold.
As mentioned above, a pre-NMS threshold is also chosen so as to disregard any boxes that are unlikely to contain an object. The higher this value the better the precision will be but the lower the recall. The lower this value, the opposite is the case. As with the IOU threshold, a balance should be found.
The maximum number of boxes that the NMS outputs should be chosen. This fixes the length of the output array as well as capping the amount of time required to process an over-crowded image. Preferably, this value is only slightly larger than the maximum number of boxes that is expected to be in an image.
Individual confidence thresholds for each class can be set. Some objects can have more distinctive features and therefore the model can pick up on these and with greater confidence when one is present than another. An object with a confidence between the pre-NMS threshold and the class threshold can be labelled undetermined. This helps with detecting but not labelling similar objects to the ones the model has been trained on but not actually seen before.

### Workflow

Preferred elements of the workflow include:
Scan a first few fields to characterize the slide using a “slide classifier”
Set path for scanning in the plane accordingly
At each point (x,y) in the plane, acquire a stack of images though thickness with z-movement
Stack those images in a format that can be interpreted by both field classifier and object detector
Perform classification of the field stack image
If the field is valid, perform object detection on the field stack image
Store field results in the test results: object, class, location, probability of class detection
Calculate the relock stack index from the grey level variance of objects (determine the most in-focus plane of the stack) and apply focus correction on the next step
Repeat until the end of the pre-determined path or condition
Report global test results

Non-essential elements of the workflow comprise:
Include results in a log book
Optionally include a QC mark on samples for those that should be checked by a human analyst (which can be determined on the basis of the result within certain bounds or picked at random)
Optionally reject samples that have a large number of defects on them

### Particular Interests

The system and method taught herein can provide a number of applications of particular interest to biologists.

### 1) Mold Spores, Pollens

The system and method enable the disambiguation of certain species: where sizes and aspects are very similar, the topography of the surface of the biological object is of interest to distinguish between, for example, penicillium and aspergillus genus and species.

They can disambiguate between pollens and mold spores within the same size range, such as Ulocladium and some spherical pollens.

Ultimately, there is no need to rely on a stain, using PCM as well

### 2) Blood

Some forms of hematocrit disorders are easily captured by the topography provided by the system and method taught herein.

The inventors have established that one can measure using phase contrast microscopy the state of thrombocytes, that is platelets, whether they are activated or not in a thin smear. This is important in cancer research.

The system and method can perform PRP counts using phase contrast, with no staining required. Basically the method and system can operate on a thin smear of known volume and extract the relative numbers of platelets and eventual RBCs and WBCs.

This can provide a full blood count with leukocytes differentiation in phase contrast microscopy without any stains being required.

While the preferred embodiments detailed above make use of the luminance of each pixel in the selection, the skilled person will appreciate that the teachings herein are not limited to used of luminance only and can be applied to any other measurable parameter of the pixels of the image. Examples include chrominance, hue, saturation and so on.

The disclosures in British patent application number GB2112652.9, from which this application claims priority, and in the abstract accompanying this application are incorporated herein by reference.

1. A system for generating sample data for analysis including:
an image capture unit configured to capture a stack of images in image layers through a thickness of a sample, each image layer comprising pixel data in two orthogonal planes across the sample at a given sample depth;
a processing unit configured:
a) to process the captured pixel data to determine therefrom a pixel value of a predetermined parameter for each pixel of the image,
b) to select from each group of pixels through the stack of images the pixel having a value meeting a predetermined parameter condition; and
c) to generate an output image file comprising a set of pixel data obtained from the selected pixels,
wherein the output image file comprises for each pixel, the pixel position in the two orthogonal planes, the pixel value and the depth position of the pixel in the image stack.

2. A system according to claim 1, wherein the predetermined parameter is energy of the pixel, determined by measured luminance.

3. (canceled)

4. A system according to claim 1, wherein the predetermined parameter condition is highest energy in the stack of pixels in the same orthogonal positions.

5. (canceled)

6. A system according to claim 1, wherein the depth position of the selected pixel for each of the orthogonal coordinate positions in the image represents a topography of a sample.

7. A system according to claim 1, including an analysis unit comprising an input for receiving the output image file and to determine therefrom sample data, including identification of constituents in the sample and/or quantity of said constituents in the sample.

8. (canceled)

9. A system according to claim, wherein 1 the image capture unit comprises a microscope with a sample holder, wherein the sample holder is movable in X-Y planes, being the two orthogonal planes, and a focus of the microscope is movable in a Z-plane orthogonal to the X-Y planes.

10-13. (canceled)

14. A system according to claim 1, wherein the system uses one of two methods to determine the maximum energy or other predetermined parameter condition for each pixel, variance and Laplacian of Gaussian, and
wherein the system:
a) computes for each image in the stack its variance and for each pixel, its position in the stack is recorded where the variance is at its maximum, providing a variance mask, or
b) performs for each image in the stack an enhancement step where a Gaussian blur is applied to the image, which is subtracted from the original image after applying a contrast enhancement factor to the two images and puts the resulting output through a second Gaussian blur filter before computing its Laplacian; wherein for each pixel, the position in the stack where the Laplacian of Gaussian (LoG) is at its maximum is taken, providing a second LoG mask for which pixel should be used from the stack.

15-16. (canceled)

17. A system according to claim 14, wherein the system is configured to determine if the value in the LoG mask is valid and if so to extract the pixel values from the stack at the position specified by the LoG mask and thereafter to compute and set RGB pixel channels and the value of from the LoG mask in the final output image file;
whereas if the value in the LoG mask is invalid for having exceeded a certain threshold, the system is configured to extract the pixel values from the stack at the position specified by the variance mask and thereafter to compute and set the RGB pixel channels and the value of from the variance mask in the final output image file.

18. A system according to claim 1, wherein the system includes an object detector configured to identify objects within the captured images, the object detector being configured to process four-channel images.

19-20. (canceled)

21. A method of generating sample data for analysis including the steps of:
capturing a stack of images in image layers through a thickness of a sample, each image layer comprising pixel data in two orthogonal planes across the sample at a given sample depth;
processing the captured pixel data to determine therefrom a pixel value of a predetermined parameter for each pixel of the image,
selecting from each group of pixels through the stack of images the pixel having a value meeting a predetermined parameter condition; and
generating an output image file comprising a set of pixel data obtained from the selected pixels,
wherein the output image file comprises for each pixel, the pixel position in the two orthogonal planes, the pixel value and the depth position of the pixel in the image stack.

22. A method according to claim 21, wherein the predetermined parameter is energy of the pixel, determined by measured luminance.

23. (canceled)

24. A method according to claim 22, wherein the predetermined parameter condition is the highest energy in the stack of pixels in the same orthogonal positions.

25-26. (canceled)

27. A method according to claim 21, including receiving at an analysis unit the output image file and determining therefrom sample data, including identification of constituents in the sample and/or quantity of said constituents in the sample.

28. (canceled)

29. A method according to claim 21, wherein the method uses one of two methods to determine the maximum energy or other predetermined parameter condition for each pixel, variance and Laplacian of Gaussian;
wherein the method:
a) computes for each image in the stack its variance and for each pixel, its position in the stack is recorded where the variance is at its maximum, providing a variance mask; or
b) performs for each image in the stack an enhancement step where a Gaussian blur is applied to the image, which is subtracted from the original image after applying a contrast enhancement factor to the two images and puts the resulting output through a second Gaussian blur filter before computing its Laplacian; wherein for each pixel, the position in the stack where the Laplacian of Gaussian (LoG) is at its maximum is taken, providing a second LoG mask for which pixel should be used from the stack.

30-31. (canceled)

32. A method according to claim 29, wherein the method comprises determining if the value in the LoG mask is valid and if so to extract the pixel values from the stack at the position specified by the LoG mask and thereafter computing and set RGB pixel channels and the value of from the LoG mask in the final output image file;
whereas if the value in the LoG mask is invalid, the method comprises extracting the pixel values from the stack at the position specified by the variance mask and thereafter computing and set the RGB pixel channels and the value of from the variance mask in the final output image file.

33. A method according to claim 21, including the step of identifying objects within the captured images.

34-35. (canceled)

36. A method according to claim 21, wherein the method includes:
scanning a first few fields to characterize a slide using a “slide classifier”
setting path for scanning in plane accordingly
at each point (x,y) in the plane, acquiring a stack of images though thickness with z-movement
stacking the resultant images in a format able for interpretation by both a field classifier and an object detector
performing classification of the field stack image
If the field is valid, performing object detection on the field stack image
storing field results in test results including: object, class, location, probability of class detection
calculating a relock stack index from a grey level variance of objects and applying focus correction on the next step
repeating the above steps until the end of a pre-determined path or condition is reached
reporting test results.

37. A method according to claim 36, wherein the method includes:
providing results in a log book
optionally providing a QC mark on samples for those that should be checked by a human analyst
optionally rejecting samples that have a large number of defects.
